(19) United States
(12) Patent Application Publication
(10) Pub. No.: US 2026/0110857 A1
(43) Pub. Date: Apr. 23, 2026

(54) OPTO-ELECTRONIC ASSEMBLY FOR CHEMICAL SENSORS

(71) Applicant: Cardiac Pacemakers, Inc.

(72) Inventors: Michael J. Kane, St. Paul, MN (US); Yingbo Li, Woodbury, MN (US); James Michael English, Cahir (IE); Laurence Norris, Clonmel (IE); Nathaniel Behning, Lino Lakes, MN (US)

(21) Appl. No.: 19/362,538

(22) Filed: Oct. 20, 2025

Related U.S. Application Data
(60) Provisional application No. 63/709,707, filed on Oct. 21, 2024.
(60) Provisional application No. 63/709,688, filed on Oct. 21, 2024.
(60) Provisional application No. 63/710,407, filed on Oct. 22, 2024.

(51) Int. Cl. G02B 6/42

(52) U.S. Cl. CPC G02B 6/4212; G02B 6/4207; G02B 6/4232; G02B 6/4239; G02B 6/428

(57) ABSTRACT

An opto-electronic assembly includes a substrate, an optical emitter coupled to the substrate, an optical detector coupled to the substrate, an optical seal at least partially surrounding the optical emitter and/or the optical detector and arranged to confine light emitted by the optical emitter. An optical fill material can be at least partially arranged within the optical seal.

### CROSS REFERENCE TO RELATED APPLICATION

This application claims priority to Provisional Application No. 63/709,701, filed Oct. 21, 2024, Provisional Application No. 63/709,688, filed Oct. 21, 2024, and Provisional Application No. 63/710,407, filed Oct. 22, 2024, which are herein incorporated by reference in its entirety.

### TECHNICAL FIELD

Instances of the present disclosure relate to electronic and/or optical components for use with chemical sensors.

### BACKGROUND

Chemical sensors can be used to measure patients'physiological parameters.

### SUMMARY

In Example 1, an apparatus includes an opto-electronic assembly. The opto-electronic assembly includes a substrate (e.g., a circuit board), an optical emitter coupled to the substrate, an optical detector coupled to the substrate, an optical seal at least partially surrounding the optical emitter and arranged to confine light emitted by the optical emitter, and, optionall, an optical fill material at least partially arranged within the optical seal.

In Example 2, the apparatus of Example 1, wherein the substrate includes a vent hole extending through a thickness direction of the substrate.

In Example 3, the apparatus of Example 1 or Example 2, wherein the substrate is formed of an opaque core material.

In Example 4, the apparatus of any of Examples 1-3, wherein the substrate further comprises an anti-reflective solder mask layer.

In Example 5, the apparatus of any of Examples 1-4, wherein the optical fill material is directly coupled to an emitting surface of the optical emitter, wherein the optical fill material is also directly coupled to a receiving surface of the optical detector.

In Example 6, the apparatus of any of Examples 1-5, wherein the optical emitter is a first optical emitter configured to emit light at a first frequency, wherein the opto-electronic assembly includes a second optical emitter coupled to the substrate and configured to emit light at a second frequency, wherein the optical seal at least partially surrounds the second optical emitter.

In Example 7, the apparatus of any of Examples 1-6, wherein the optical fill material is an adhesive.

In Example 8, the apparatus of any of Examples 1-7, wherein the optical emitter is a light-emitting diode, wherein the optical detector is a photodiode.

In Example 9, the apparatus of any of Examples 1-8, wherein the apparatus is an implantable medical device with a housing that houses the opto-electronic assembly, wherein the optical emitter and the optical detector are directly coupled to a first major surface of the substrate, wherein a desiccant is directly coupled to a second major surface of the substrate and to the housing.

In Example 10, the apparatus of any of Examples 1-9, further including an optical feedthrough assembly. The optical feedthrough assembly includes a bottom portion, a side wall portion surrounding a periphery of the bottom portion to create a well, and a first window and a second window formed through the bottom portion of the optical feedthrough. The first window is arranged to receive the light emitted by the optical emitter, and the second window is arranged to pass reflected light to the optical detector.

In Example 11, the apparatus of Example 10, wherein optical fill material at least partially fills a first region between the first window and an emitting surface of the optical emitter.

In Example 12, the apparatus of Example 11, wherein the optical fill material at least partially fills a second region between the second window and a detecting surface of the optical detector.

In Example 13, the apparatus of Example 10, further comprising a chemical sensor cassette at least partially positioned in the well.

In Example 14, the apparatus of Example 13, wherein the chemical sensor cassette comprises bottom apertures respectively aligned with the first window and the second window.

In Example 15, the apparatus of Example 14, wherein the optical chemical sensor cassette further includes a cassette housing with the bottom apertures respectively facing the optical emitter and the optical detector, a reflector coupled to the cassette housing, and a chemical indicator in the cassette housing. The reflector is configured to direct the emitted light to the chemical indicator.

In Example 16, an apparatus includes an opto-electronic assembly. The opto-electronic assembly includes a substrate, an optical emitter coupled to the substrate, an optical detector coupled to the substrate, an optical seal at least partially surrounding the optical emitter and arranged to confine light emitted by the optical emitter, and, optionally, an optical fill material at least partially arranged within the optical seal.

In Example 17, the apparatus of Example 16, wherein the substrate includes a vent hole extending through a thickness direction of the substrate.

In Example 18, the apparatus of Example 16, wherein the substrate is formed of an opaque core material.

In Example 19, the apparatus of Example 16, wherein the substrate further comprises an anti-reflective solder mask layer.

In Example 20, the apparatus of Example 16, wherein the optical fill material is directly coupled to an emitting surface of the optical emitter, wherein the optical fill material is also directly coupled to a receiving surface of the optical detector.

In Example 21, the apparatus of Example 16, wherein the optical emitter is a first optical emitter configured to emit light at a first frequency, wherein the opto-electronic assembly includes a second optical emitter coupled to the substrate and configured to emit light at a second frequency, wherein the optical seal at least partially surrounds the second optical emitter.

In Example 22, the apparatus of Example 16, wherein the optical fill material is an adhesive.

In Example 23, the apparatus of Example 16, wherein the optical emitter is a light-emitting diode, wherein the optical detector is a photodiode.

In Example 24, the apparatus of Example 16, wherein the apparatus is an implantable medical device with a housing that houses the opto-electronic assembly, wherein the optical emitter and the optical detector are directly coupled to a first major surface of the substrate, wherein a desiccant is directly coupled to a second major surface of the substrate and to the housing.

In Example 25, the apparatus of Example 16, further including an optical feedthrough assembly with a bottom portion, a side wall portion surrounding a periphery of the bottom portion to create a well, and a first window and a second window formed through the bottom portion of the optical feedthrough. The first window is arranged to receive the light emitted by the optical emitter, and the second window is arranged to pass reflected light to the optical detector.

In Example 26, the apparatus of Example 25, wherein optical fill material at least partially fills a first region between the first window and an emitting surface of the optical emitter.

In Example 27, the apparatus of Example 26, wherein the optical fill material at least partially fills a second region between the second window and a detecting surface of the optical detector.

In Example 28, the apparatus of Example 25, further comprising a chemical sensor cassette at least partially positioned in the well.

In Example 29, the apparatus of claim 28, wherein the chemical sensor cassette comprises bottom apertures respectively aligned with the first window and the second window.

In Example 30, the apparatus of Example 29, wherein the optical chemical sensor cassette further includes a cassette housing with the bottom apertures respectively facing the optical emitter and the optical detector, a reflector coupled to the cassette housing, and a chemical indicator in the cassette housing. The reflector is configured to direct the emitted light to the chemical indicator.

In Example 31, a method includes coupling the optical emitter to a substrate, coupling the optical detector to the substrate, positioning an optical seal to at least partially surround the optical emitter, and depositing an optical fill material onto the optical emitter within a space created by the optical seal.

In Example 32, the method of Example 31, further includes coupling an optical feedthrough assembly to the opto-electronic assembly and applying a pressure to force the optical fill material through a vent hole in the substrate.

In Example 33, the method of Example 32, wherein optical fill material is directly coupled between an emitting surface of the optical emitter and to a window in the optical feedthrough assembly.

In Example 34, the method of Example 31, further includes coupling an optical feedthrough assembly to the opto-electronic assembly and inserting a cassette into a well of the optical feedthrough. The cassette includes a chemical indicator that changes color with changes in analyte concentrations.

In Example 35, the method of Example 31, further includes curing the optical fill material.

In Example 36, an apparatus includes an opto-electronic assembly. The opto-electronic assembly includes a substrate, an optical emitter coupled to the substrate, an optical detector coupled to the substrate, an optical seal at least partially surrounding the optical detector and arranged to confine light directed towards the optical detector. Optionally, an optical fill material is at least partially arranged within the optical seal.

In Example 37, an apparatus includes an opto-electronic assembly. The opto-electronic assembly includes a substrate, an optical emitter coupled to the substrate, an optical detector coupled to the substrate, an optical seal at least partially surrounding the optical emitter and arranged to confine light emitted by the optical emitter. Optionally, an optical fill material is at least partially arranged within the optical seal.

In Example 38, an apparatus includes a chemical sensor cassette. The chemical sensor cassette includes a cassette housing including an interior space, a first aperture, and a second aperture; a first reflector and a second reflector positioned in the interior space; and a first chemical indicator positioned in the interior space. The first reflector is arranged to receive light from the first aperture towards the first chemical indicator. The second reflector is arranged for one of the following: (1) to receive light from the second aperture and reflect light towards a second chemical indicator positioned in the cassette housing, (2) to receive light from the second aperture and reflect light towards the first chemical indicator, or (3) to receive light reflected by the first reflector and reflect light towards the second aperture.

In Example 39, the apparatus of Example 38, wherein the first chemical indicator is positioned between the first reflector and the second reflector.

In Example 40, the apparatus of Example 39, wherein: the chemical sensor cassette further comprises a third aperture, the first optical reflector is aligned with the first aperture, the second optical reflector is aligned with the second aperture, and the first chemical indicator is aligned with the third aperture.

In Example 41, the apparatus of any of Examples 38-40, wherein the first reflector is a flat reflector.

In Example 42, the apparatus of any of Examples 38-41, wherein the first reflector and the second reflector are angled at 30 to 60 degrees relative to a bottom surface of the interior space.

In Example 43, the apparatus of any of Examples 38-41, wherein the first reflector is a curved reflector.

In Example 44, the apparatus of any of Examples 38-43, wherein the cassette housing has standoff protrusions positioned at or near each corner of the cassette housing.

In Example 45, the apparatus of any of Examples 38-44, wherein the chemical sensor cassette further comprises the second chemical indicator positioned in the cassette housing, and the second reflector is arranged to receive light from the second aperture and reflect light towards the second chemical indicator.

In Example 46, the apparatus of Example 45, wherein the first reflector and the second reflector are positioned between the first chemical indicator and the second chemical indicator.

In Example 10, the apparatus of Example 38, wherein the second reflector is arranged to receive light from the second aperture and reflect light towards the first chemical indicator.

In Example 47, the apparatus of Example 38, wherein the second reflector is arranged to receive light reflected by the first reflector and reflect light towards the second aperture.

In Example 48, the apparatus of Example 47, wherein the light reflected by the first reflector transmits through the first chemical indicator before being reflected by the second reflector towards the second aperture.

In Example 49, the apparatus of any of Examples 38-48, further includes an optical feedthrough. The optical feedthrough includes a bottom portion and a side wall portion surrounding a periphery of the bottom portion to create a well. The chemical sensor cassette is at least partially positioned in the well. A first window and a second window are formed through the bottom portion of the optical feedthrough and respectively aligned with the first aperture and the second aperture.

In Example 50, the apparatus of Example 49, further including an opto-electrical assembly. The opto-electrical assembly includes a circuit board, an optical emitter coupled to the circuit board, and an optical detector coupled to the circuit board. The optical emitter is arranged to direct light through the first window and through the first aperture. The optical detector is arranged to receive light reflected through the second window and the second aperture.

In Example 51, the apparatus of Example 50, wherein the opto-electrical assembly further includes an optical seal at least partially surrounding the optical emitter and arranged to confine light emitted by the optical emitter. An optical fill material is at least partially arranged within the optical seal.

In Example 52, a method includes inserting a chemical sensor cassette into a well of an optical feedthrough assembly, aligning an aperture of the chemical sensor cassette with a window of the optical feedthrough assembly, and securing the chemical sensor cassette to the optical feedthrough assembly.

In Example 53, the method of Example 52, further including directing light from one or more optical emitters towards a reflector in the chemical sensor cassette, exciting the chemical indicator, and sensing an optical property of the chemical indicator.

In Example 54, the method of Example 53, further including estimating an analyte concentration based, at least in part, on the optical property.

In Example 55, the method of Example 52, further including aligning the window with an optical path of an optical emitter.

In Example 56, the method of Example 52, further including aligning the window with a sensing surface of an optical detector.

In Example 57, an apparatus includes an optical feedthrough and a chemical sensor cassette. The optical feedthrough includes a bottom portion, a side wall portion surrounding a periphery of the bottom portion to create a well, and a first window and a second window formed through the bottom portion of the optical feedthrough. The chemical sensor cassette is at least partially positioned in the well and includes a first aperture and a second aperture.

In Example 58, the apparatus of Example 57, wherein the bottom portion and the side wall portion comprise a biocompatible and electrically-conductive material.

In Example 59, the apparatus of any of Examples 57 or 58, wherein the bottom portion and the side wall portion comprise titanium.

In Example 60, the apparatus of any of Examples 57-59, wherein the first window and a second window comprise quartz, silica, or sapphire.

In Example 61, the apparatus of any of Examples 57-60, wherein an anti-reflective coating is disposed on the first window and a second window.

In Example 62, the apparatus of any of Examples 57-61, wherein a first seal surrounds the first window, wherein a second seal surrounds the second window.

In Example 63, the apparatus of Example 6, wherein the first seal and the second seal comprise gold, nickel, or titanium.

In Example 64, the apparatus of any of Examples 57-63, wherein the apparatus is an implantable medical device that includes a housing, wherein the optical feedthrough is welded to the housing.

In Example 65, the apparatus of any of Examples 57-64, wherein the chemical sensor cassette further includes a first optical reflector, a second optical reflector, and a first chemical indicator.

In Example 66, the apparatus of Example 65, wherein the first reflector is arranged to receive light from the first aperture towards a chemical indicator in the chemical sensor cassette, wherein the second reflector is arranged for one of the following: (1) to receive light from the second aperture and reflect light towards a second chemical indicator positioned in the cassette housing, (2) to receive light from the second aperture and reflect light towards the first chemical indicator, or (3) to receive light reflected by the first reflector and reflect light towards the second aperture.

In Example 67, the apparatus of Example 65, wherein the first aperture is aligned with the first window, the second aperture is aligned with the second window, the optical feedthrough further comprises a third window, and the chemical sensor cassette further comprises a third aperture aligned with the third window.

In Example 68, the apparatus of any of Examples 57-67, wherein the first aperture and the second aperture comprise respective windows that have a first index of refraction, wherein the first window and the second window have a second index of refraction that is within 5% of the first index of refraction.

In Example 69, the apparatus of any of Examples 57-68, further including an opto-electronic assembly. The opto-electronic assembly includes a circuit board, an optical emitter coupled to the circuit board, and an optical detector coupled to the circuit board. The optical emitter is arranged to direct light through the first window of the optical feedthrough and through the first aperture of the chemical sensor cassette. The optical detector is arranged to receive light passing through the second window and the second aperture.

In Example 70, the apparatus of Example 69, wherein the opto-electronic assembly further includes an optical seal at least partially surrounding the optical emitter and arranged to confine light emitted by the optical emitter. An optical fill material is at least partially arranged within the optical seal.

In Example 71, the apparatus of Example 70, wherein the optical fill material is disposed between an emitting surface of the optical emitter and the first window of the optical feedthrough. The optical fill material is also disposed between a receiving surface of the optical detector and the second window of the optical feedthrough.

In Example 72, an optical feedthrough assembly includes a bottom portion, a side wall portion surrounding a periphery of the bottom portion to create a well, a first optical window and a second optical window formed through the bottom portion of the optical feedthrough assembly, a bonding material along outer perimeters of the first optical window and the second optical window, a first metallic seal surrounding the first optical window, and a second metallic seal surrounding the second optical window.

In Example 73, an optical feedthrough assembly includes a bottom portion, a side wall portion surrounding a periphery of the bottom portion to create a well, an optical window formed through the bottom portion of the optical feedthrough assembly, a bonding material along an outer perimeter of the optical window, and a metallic seal surrounding the optical window.

In Example 74, an optical feedthrough assembly includes a bottom portion, a side wall portion surrounding a periphery of the bottom portion to create a well, an optical window formed through the bottom portion of the optical feedthrough assembly, and a metallic seal surrounding the optical window.

In Example 75, an optical feedthrough assembly comprises a metal body with an aperture, includes a bottom portion, a side wall portion surrounding a periphery of the bottom portion to create a well, an optical window formed through the bottom portion of the optical feedthrough assembly, and a metallic seal surrounding the optical window.

In Example 76, a method includes coating a sidewall of an optical window with a bonding material and forming a metal seal between the optical window and a metal body of the optical feedthrough assembly via brazing or diffusion bonding.

In Example 77, the method of Example 76, wherein the metal seal material comprises gold, nickel, or titanium.

In Example 78, the method of Examples 76 or 77, wherein the bonding material comprises titanium, chromium, molybdenum, tantalum, niobium, vanadium, tungsten, platinum, palladium, ruthenium, or iridium.

In Example 79, the method of any of Examples 76-78, wherein the coating the sidewall comprises vapor deposition, sputtering, plasma spraying, or thermal evaporation of the bonding material to the sidewall.

In Example 80, the method of any of Examples 76-79, wherein the metal body forms a well.

In Example 81, the method of Example 80, further including inserting a chemical sensor cassette into the well and coupling the chemical sensor cassette to the optical feedthrough assembly, wherein the chemical sensor cassette includes a chemical indicator.

While multiple instances are disclosed, still other instances of the present disclosure will become apparent to those skilled in the art from the following detailed description, which shows and describes illustrative instances of the disclosure. Accordingly, the drawings and detailed description are to be regarded as illustrative in nature and not restrictive.

### BRIEF DESCRIPTION OF THE DRAWINGS

FIG. 1 is a schematic illustration of a chemical sensing system, in accordance with certain instances of the present disclosure.

FIG. 2 shows an implantable medical device with a chemical sensor, in accordance with certain instances of the present disclosure.

FIG. 3 shows an exploded view of the implantable medical device of FIG. 2, in accordance with certain instances of the present disclosure.

FIG. 4A shows a schematic cross-sectional view of portions of the implantable medical device of FIG. 2, in accordance with certain instances of the present disclosure.

FIG. 4B shows a schematic cross-sectional view of an enlarged portion of the implantable medical device of FIG. 4A, in accordance with certain instances of the present disclosure.

FIG. 5A shows a schematic cross-sectional view of an optical feedthrough, in accordance with certain instances of the present disclosure.

FIG. 5B shows a schematic top view of the optical feedthrough of FIG. 5A, in accordance with certain instances of the present disclosure.

FIG. 5C shows a schematic bottom view of the optical feedthrough of FIG. 5A, in accordance with certain instances of the present disclosure.

FIG. 6A shows a schematic cross-sectional view of a chemical sensor cassette, in accordance with certain instances of the present disclosure.

FIG. 6B shows a schematic bottom view of the chemical sensor cassette of FIG. 6A, in accordance with certain instances of the present disclosure.

FIG. 6C shows a schematic top view of the chemical sensor cassette of FIG. 6A positioned in the optical feedthrough of FIG. 5A, in accordance with certain instances of the present disclosure.

FIG. 7A shows a schematic cross-sectional view of a chemical sensor cassette positioned in an optical feedthrough, in accordance with certain instances of the present disclosure.

FIG. 7B shows a schematic cross-sectional view of a chemical sensor cassette positioned in an optical feedthrough, in accordance with certain instances of the present disclosure.

FIG. 7C shows a schematic cross-sectional view of a chemical sensor cassette positioned in an optical feedthrough, in accordance with certain instances of the present disclosure.

FIG. 8 shows a block diagram of a method, in accordance with certain instances of the present disclosure.

FIG. 9 shows a block diagram of circuitry of the implantable medical device of FIG. 2, in accordance with certain instances of the present disclosure.

While the disclosed subject matter is amenable to various modifications and alternative forms, specific instances have been shown by way of example in the drawings and are described in detail below. The intention, however, is not to limit the disclosed subject matter to the particular instances described. On the contrary, the disclosed subject matter is intended to cover all modifications, equivalents, and alternatives falling within the scope of the disclosed subject matter as defined by the appended claims.

### DETAILED DESCRIPTION

Physiological parameters such as concentrations of certain analytes (e.g., levels of potassium, sodium, creatinine, and other analytes) can be measured and monitored to evaluate various physical conditions and performance such as a person's kidney and/or cardiac conditions and performance.

Typically, measuring a person's analyte concentrations requires drawing multiple blood samples from a patient at a clinic and then processing the blood samples at a laboratory. One approach for measuring analyte concentrations that does not require periodic blood draws, etc., is to use an implantable chemical sensor. An implantable chemical sensor can use opto-electronic components such as light emitters and light detectors to sense one or more optical properties. Optical properties can used to estimate analyte concentrations.

### Chemical Sensing System

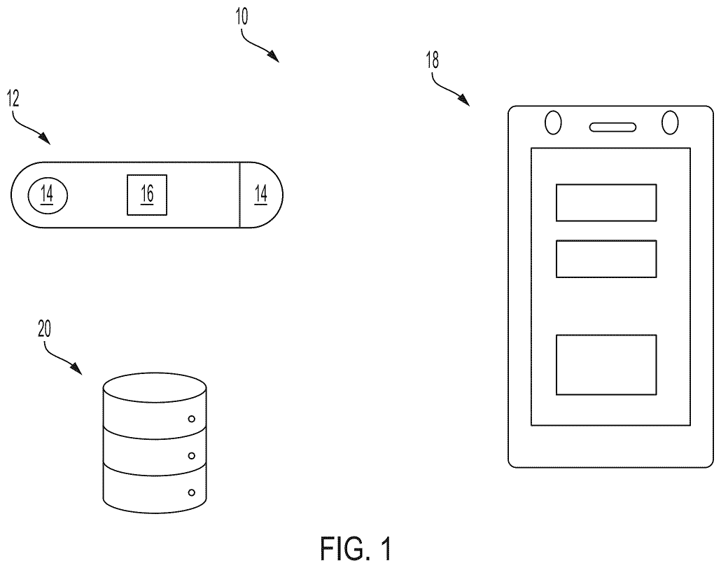

FIG. 1 shows a chemical sensing system 10 (hereinafter “the system 10” for brevity) with schematic representations of components that can be used to sense, measure, and monitor physiological parameters. In particular, components of the system 10 can ultimately be used to estimate analyte concentrations and pH levels using an implantable medical device.

The system 10 includes an implantable medical device 12, which includes one or more electrodes 14 and a chemical sensor assembly 16. The electrodes 14 can comprise a conductive material and be configured to sense cardiac activation signals. Cardiac activation signals can be used to generate electrocardiogram (ECG) data. In some instances, the implantable medical device 12 does not include electrodes.

The chemical sensor assembly 16 can include a sensing element with a polymeric matrix permeable to analytes such as potassium, sodium, and/or creatinine. The sensing element can include an interior volume with various chemical indicators (e.g., beads or film for detecting an ion concentration of a bodily fluid when implanted in the body). Analytes can diffuse through an outer barrier layer and onto and/or into the chemical indicators where the analytes can bind with ion selective sensors to produce an optical response (e.g., a change in optical properties such as a change in concentration, a fluorimetric response, a colorimetric response). The optical response can be monitored and used to estimate analyte levels (e.g., analyte concentrations).

The system 10 can also include a computing device 18 such as a mobile computing device (e.g., a smart phone, a tablet, and the like) and/or a computing system 20 (e.g., a server). Estimated analyte levels can be used by the computing device 18 to monitor and evaluate a person's kidney and/or cardiac performance among other functions. In certain instances, the implantable medical device 12 itself is programmed to estimate analyte levels based on optical properties of the chemical sensor. Additionally or alternatively, the computing device 18 and/or computing system 20 is programmed to estimate analyte levels, etc. The device 18 and/or the computing system 20 can communicate (e.g., wirelessly) with the implantable medical device 12 and each other.

### Implantable Medical Device

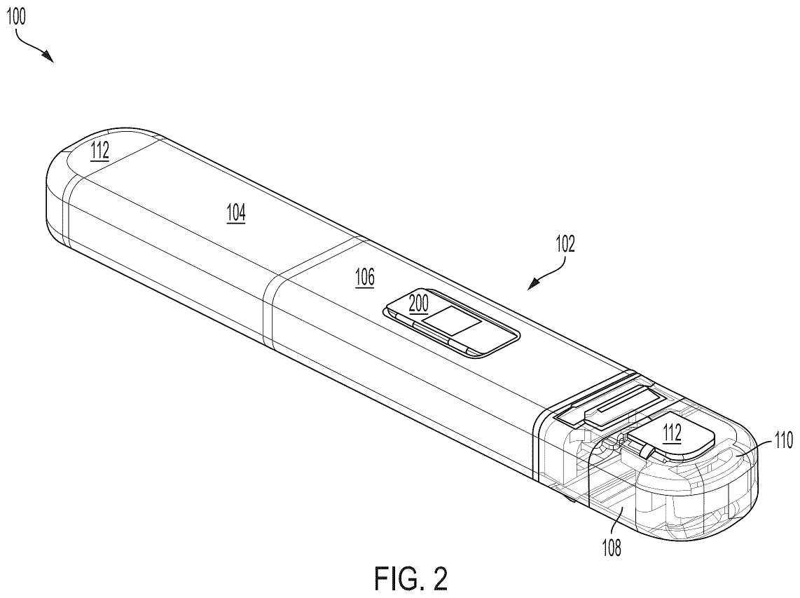

FIG. 2 shows an implantable medical device (IMD) 100 that includes a body 102 with various sections such as a battery module 104 (e.g., a section that houses a battery), an electronics housing 106 (e.g., a section that is hollow and houses various electronics such as a printed circuit board, integrated circuitry such as controllers and processors, and the like), a header 108 (e.g., a section that houses components such as an antenna 110), and electrodes 112 at opposite ends of the body 102. In certain instances, the IMD 100 is header-less.

The battery module 104 can include an electrochemical cell disposed therein to provide power for the IMD 100. The electrochemical cell can be a single-use cell (e.g., a primary lithium-based cell) or a rechargeable cell (e.g., a secondary lithium-ion-based call). Rechargeable cells can comprise a rechargeable lithium-based cell such as a lithium-manganese dioxide (Li anode/MnO2 cathode) battery, however, other primary lithium battery chemistries are also contemplated herein —including, but are not limited to, CFx, SVO, hybrid CFx/Mn02, hybrid CFx/SVO, and the like.

The electrodes 112 comprise a conductive material and are arranged to sense cardiac activation signals.

The IMD 100 also includes a chemical sensor assembly 200 (hereinafter “the chemical sensor 200” for brevity). The chemical sensor 200 can include one or more chemical indicators that are in communication (e.g., indirect communication) with a person's blood. For example, the indicators may be exposed to interstitial fluid, which is in communication with blood. As described further herein, the chemical indicators can change optical properties as analyte levels change. Estimating an analyte level using the chemical sensor 200 can include sensing one or more optical properties of the chemical sensor 200 and estimating an analyte level based on the optical property. In certain instances, estimating an analyte level occurs periodically (e.g., every 30 minutes, once an hour) or on demand (e.g., when a patient or physician initiates the comparison). Although the chemical sensors may react in real-time (e.g., the chemical indicators change optical properties in real-time as analyte levels change in real-time), transmission of or estimating an analyte level less often can save computing and battery resources and may be preferable because analyte levels may not change significantly minute-by-minute.

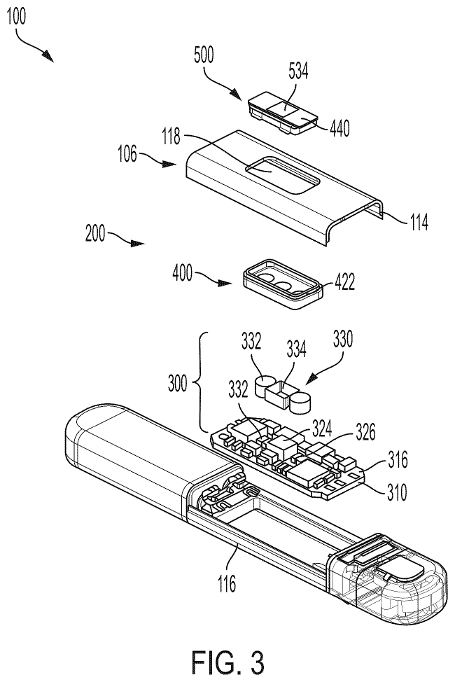

FIG. 3 shows an exploded view of the IMD 100 and, in particular, components of the chemical sensor 200. The chemical sensor 200 is described herein as including various subassemblies. As before, the IMD 100 includes an electronics housing 106 that is hollow and houses various electronics including at least some subassemblies of the chemical sensor 200. The electronics housing 106 includes a top housing shell 114 and a bottom housing shell 116. The top housing shell 114 and the bottom housing shell 116 can be formed of a biocompatible electrically conductive material such as, for example, titanium or a titanium alloy. In various instances, the top housing shell 114 and the bottom housing shell 116 can be attached together (e.g., by welding such as laser welding, by brazing, and the like) along intersecting edges thereof, such as the lateral edges thereof. The top housing shell 114 and the bottom housing shell 116 can define a space there between to hold various components, including subassemblies of the chemical sensor 200 herein. In some instances, self-aligning mechanisms (e.g., liners, fiducials, marks, and the like) can be positioned on a bottom surface of the bottom housing shell 116 to facilitate vertical stacking of the subassemblies with a desired tolerance. Other housing designs can be used with the chemical sensor 200. For example, the housing could comprise fewer separate sections that are made from materials such as ceramics, plastics, sapphire, etc.

In the instance depicted in FIG. 3, the subassemblies of the chemical sensor 200 include an opto-electronic assembly 300, an optical feedthrough 400, and a chemical sensor cassette 500. It is to be understood that the chemical sensor 200 can include other subassemblies or components which may be coupled to one or more of the opto-electronic assembly 300, the optical feedthrough 400, and the chemical sensor cassette 500.

FIG. 3 shows the opto-electronic assembly 300 including a circuit board 310, optical emitters 322 and 326 coupled to the circuit board 310, and an optical detector 324 coupled to the circuit board 310. The circuit board 302 can include a wide variety of substrates with metallic conductors. For example, the circuit board 302 can include a ceramic substrate, a silicon wafer substrate, or other types of substrates with metallic conductors.

The opto-electronic assembly 300 further includes an optical seal 330. The optical seal 300 can have various designs. In one design, the optical seal 300 is shaped and positioned to at least partially surround the optical detector 324 (and not to surround the optical emitters 322 and 326). In another design, the optical seal 300 at least partially surrounds the optical emitters 322 and 326 but not the optical detector 324. In another design, the optical seal 330 (or multiple separate optical seals) surround both the optical emitters 322 and 326 and the optical emitter 324. The optical seal 330 is arranged to confine light emitted by the optical emitters 322 and 326 and reduce undesirable light leak paths when light transmits from the optical emitters 322 and 326 into the chemical sensor cassette 500. When surrounding the optical detector 324, the optical seal 330 reduce undesirable light leak paths out of or passed into the area within the optical seal 330.

The optical feedthrough 400 can fit into a sensor window 118 defined by the top housing shell 114. The optical feedthrough 400 creates a well 422. The chemical sensor cassette 500 can be at least partially positioned in the well 422. In some instances, the chemical sensor cassette 500 can be releasably attached to the optical feedthrough 400 and/or the top housing shell 114 such that the chemical sensor cassette 500 is exchangeable to allow easy switching of analytes and enable pre-calibration and testing without dissembling other components of the chemical sensor 200. A top cover 440 can be used for one or more functions such as a mechanical shield, a screen (e.g., coarse grid) for porosity, a matrix for stabilizing a bio interface material like fibers or hydrogel, and/or a retainer to confine the chemical sensor cassette 500 in the well 422.

In various instances, the optical emitters 322 and 326 can be configured to emit light which is confined by the optical seal 330 and directed through the optical feedthrough 400 and into the chemical sensor cassette 500 disposed in the well 422. Such light can interface with a chemical indicator of the chemical sensor cassette 500, being scattered or transmitted, and can be directed downwards back through the optical feedthrough 400 to the optical detector 324.

### Opto-Electronic Assembly

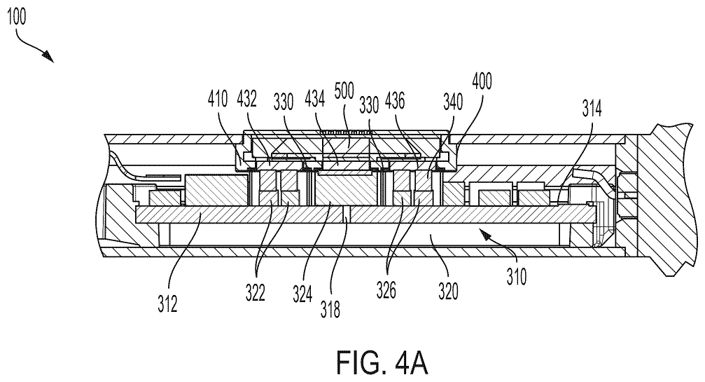

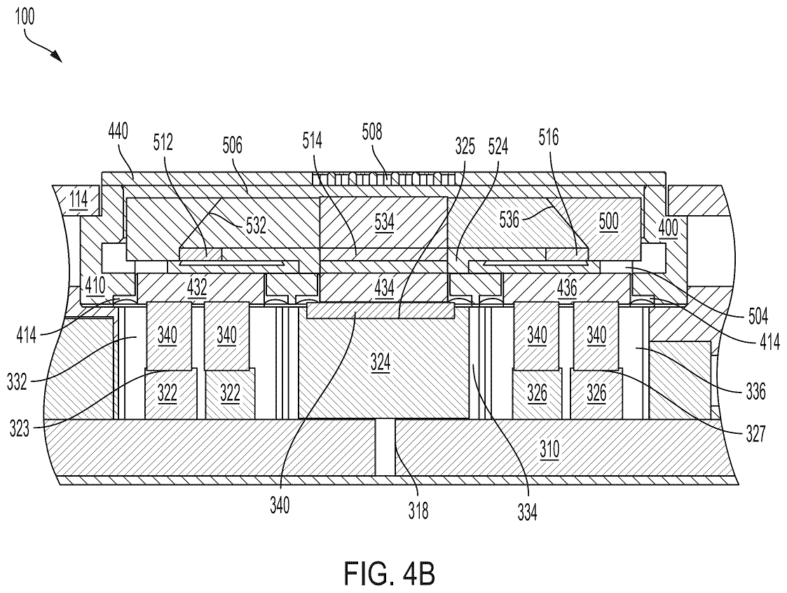

Referring now to FIGS. 4A and 4B, a schematic cross-sectional view of portions of the IMD 100 are shown in accordance with various instances herein. As before, the opto-electronic assembly 300 includes the circuit board 310, optical emitters 322 and 326 coupled to the circuit board 310, and the optical detector 324 coupled to the circuit board 310. The opto-electronic assembly 300 further includes the optical seal 330 at least partially surrounding the optical emitters 322 and 326 and/or the optical detector 324. The optical seal 330 is arranged to confine light emitted by the optical emitters 322 and 326.

In some instances, the circuit board 310 has a body 312 formed of an opaque core material. The opaque core material can help reduce light reflection and leak paths. In some instances, the opaque core material can include carbon black and/or various pigments or components to render the body 312 opaque.

As shown in FIGS. 4A and 4B, the circuit board 310 further includes a solder mask layer 314 that forms a first major surface 316 of the circuit board 310. The solder mask layer 314 has a relatively darker color than typical green solder masks commonly used for circuit boards and therefore is better able to reduce light reflection and leak paths. As such, the solder mask layer 314 can be considered to be anti-reflective. In certain instances, the solder mask layer 314 is a darker color than a core material of the circuit board. The solder mask layer 314 can be formed of a polymeric material that is disposed (e.g., screened, sprayed, and the like) to create the first major surface 316 and to prevent solder from adhering thereon.

Components such as the optical emitters 322 and 326 and the optical detector 324 can be coupled to (e.g., mechanically directly coupled to) the first major surface 316 of the circuit board 310 as surface mount hardware components promoting a compact configuration. While four optical emitters and one optical detector are illustrated in FIGS. 4A-4B, a different number of optical emitters and a different number of optical detectors can be used with the IMD 100. Various options for the optical emitters and optical detectors will be described below, but in some instances the optical detector 324 is a photodiode and the optical emitters 322 and 326 are light emitting diodes (LEDs). In certain instances, separate circuit boards could be used such that the optical emitter(s) and optical detector(s) are directly coupled to different circuit boards.

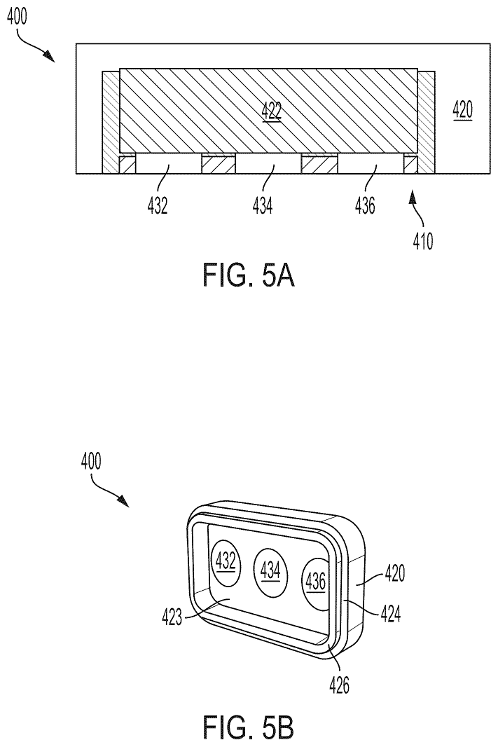

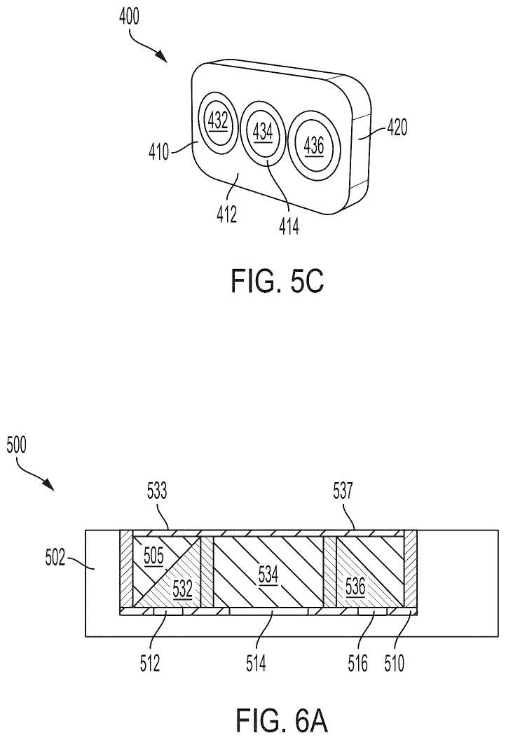

As shown in FIGS. 3 and 4, the optical seal 330 includes a first optical sealing component 332 at least partially surrounding the optical emitters 322 and 326 and arranged to confine light emitted by the optical emitters 322 and 326. In some instances, the first optical sealing component 332 can be a gasket (e.g., an O-ring) that surrounds a periphery of an emitting surface of one or more of the optical emitters 322 and/or 326 such that light from the respective emitting surfaces of the optical emitters 322 and/or 326 can be confined and directed to a first optical window of the optical feedthrough 400 (e.g., optical windows 432 and 436, see also FIG. 5A). The first optical sealing component 332 can reduce undesirable light leak paths when light transmits from the optical emitters 322 and/or 326 into the first optical windows.

The optical seal 330 further includes a second optical sealing component 334 at least partially surrounding the optical detector 324 and arranged to confine light directed towards the optical detector 324. In some instances, the second optical sealing component 334 can be a gasket that surrounds a periphery of a receiving surface of the optical detector 324 such that light from a second optical window (e.g., the optical window 434, see also FIG. 5A) can be confined and directed to the receiving surface of the optical detector 324. The second optical sealing component 334 can reduce undesirable light leak paths when light transmits from the second optical window onto the receiving surface of the optical detector 324. In some instances, the optical seal 330 can be formed of a variety of materials. Examples includes an opaque elastic material such as, for example, a dark (e.g., black) rubber-based material, a dark silicone elastomer, a non-opaque base material that is coated with a reflective or absorptive material, etc. The optical seal 330 includes a third optical sealing component 336 at least partially surrounding the optical emitters not surrounded by the first optical sealing component 332. The third optical sealing component 336 can configured and function similarly to the first optical sealing component 336.

The optical seal 330 can be formed in one piece, and the optical sealing components can be different sections or portions of the optical seal 330. Each optical sealing component can include a wall and an open interior portion surrounded by the wall. When the chemical sensor is assembled, the walls can extend between the first major surface 316 of the circuit board 310 and a bottom surface of the optical feedthrough 400. The optical sealing components can form various shapes such as a hollow cylinder, hollow rectangle, hollow square, and the like. In the example of FIG. 3, the parts of the optical seal 330 surrounding the optical emitters are cylinder-shaped, and the part of the optical seal 330 surrounding the optical detector is rectangular-shaped. Other shapes or combinations can be used. The optical seal 330 can be coupled to the circuit board 310 via an adhesive (e.g., a contact adhesive, a single-face adhesive) that is applied to an outer surface of the optical seal 330.

The opto-electronic assembly 300 further includes an optical fill material 340 at least partially arranged within the optical seal 330. As shown in FIG. 4B, the optical fill material 340 is disposed on the respective emitting surfaces 323 and 327 of the optical emitters 322 and 326. The optical seal 330 defines a first region between respective emitting surfaces 323/327 and respective optical windows 432/436 of the feedthrough 400, which can be filled with the optical fill material 340. The optical fill material 340 is also disposed on the receiving surface 325 of the optical detector 324. The optical seal 330 (e.g., via the second optical sealing component 334) defines a second region between the receiving surface 325 and the second optical window 434, which can also be filled with the optical fill material 340. The first region has a first depth, e.g., a distance between respective emitting surfaces 323/327 of the optical emitters 322/326 and the optical windows 432/436. The second region has a second depth, e.g., a distance between the receiving surface 325 of the optical detector 324 and the second optical window 434. In some instances, the first depth is greater than the second depth because the optical emitters are shorter than the optical detector. For example, the first depth can be 2-10 times (e.g. two times, five times, ten times) greater than the second depth.

The optical fill material 340 can be comprised of an optically transparent adhesive or optically clear adhesive. The optical fill material 340 can be used to fill the first region between the emitting surface 323/327 of the optical emitters 322/326 and a corresponding optical window 432/436 of the optical feedthrough 400. The optical fill material 340 can contact the components and provide adhesive bonding. The optical fill material 340 can also be used to fill the second region between the receiving surface of the optical detector 324 and a corresponding optical window 434 of the optical feedthrough 400. In some instances, the optical fill material 340 can adhere to an optical window (e.g., the optical windows 432, 434 or 436) of the optical feedthrough 400. The optical fill material 340 can be one with an index of refraction approximately matching (e.g., +/−5%) the components being adhered/joined, such as the optical windows of the optical feedthrough 400. Optically transparent adhesives can include various acrylics, silicones, and the like.

The optical fill material 340 can be applied in the form of liquid adhesive to fill the first and second regions by any suitable methods such as, for example, dispensing, spraying, coating, brushing, and the like. In some instances, the optical seal 330 can include an adhesive relief port. The relief port can be positioned in the wall of the optical seal such that excess material, air, etc., can pass through the walls in the event too much optical fill material 340 is applied. The relief port and can extend along a plane that is parallel to the longitudinal axis of the IMD 100.

When the optical fill material 340 is applied to fill the first and/or second regions, excessive air and/or optical fill material 340 can be directed through one or more adhesive relief ports and/or vent holes 318 in the circuit board 310. The optical fill material 340 can pass through the one or more vents hole 318 and to the backside of the circuit board 310. For example, when the optical feedthrough 400 is assembled with the opto-electronic assembly 300, a bottom portion of the optical feedthrough 400 can sit on the top of the optical seal 330 to push excessive air or optical fill material 340 into and through the vent hole 318 and to the backside of the circuit board 310. In certain instances, a separate vent hole is positioned in the circuit board 310 below each area that the optical seal 330 separately seals such that there is a path for excess air or material for each area. Using the relief port(s) and/or vent hole(s), the first and second regions can be filled with the optical fill material 340 and reduce gaps, bubbles, and the like, inside the first or second region to better control light transmission from the optical emitters to desired regions of the chemical sensor. In some instances, the optical fill material 340 can be UV-curable or thermally curable adhesive which can be cured to mechanically and optically couple between respective emitting surfaces of the optical emitter and the corresponding optical window, and optically couple the receiving surface of the optical detector and the respective optical window. The optical fill material 340 can act as a waveguide for light.

As shown in FIG. 4A, in some instances, a cushion 320 (e.g., comprising an elastic or otherwise deformable material) is positioned between the circuit board 310 and the housing of the implantable medical device. The cushion 320 can include a desiccant or drying agent to control the moisture inside the opto-electronic assembly 300 and to support the circuit board 310 when the circuit board 310 is subjected to forces.

In certain instances, the optical emitters described herein can include solid state light sources such as, for example, GaAs, GaAlAs, GaAlAsP, GaAlP, GaAsp, GaP, GaN, InGaAlP, InGaN, ZnSe, or SiC light emitting diodes or laser diodes that can excite a chemical indicator at or near the wavelength of maximum absorption for a time sufficient to emit a return signal. It is to be understood that in some instances the wavelength of maximum absorption reflection varies as a function of concentration in the chemical indicator. In some instances, the optical emitters can include a wave guide. The optical emitters can also include one or more bandpass filters, high pass filter, low pass filter, antireflection elements, and/or focusing optics.

In some instances, the opto-electronic assembly 300 can include a plurality of LEDs with filters (e.g., band-limiting filters such as bandstop filters, bandpass filters, low-pass filters, high-pass filters). Each of the LED-filter combinations emitting at a different center frequency. According to various instances, the LEDs can operate at different center-frequencies, sequentially turning on and off during a measurement, illuminating the chemical indicator. As multiple different center-frequency measurements are made sequentially, a single unfiltered detector can be used in some instances. It is to be understood that, in some instances, a polychromatic source can be used with multiple optical detectors that are each bandpass filtered to a particular center frequency.

The optical detector(s) can be configured to receive light from the chemical indicator and include components such as a photodiode, charge-coupled device (CCD), a junction field effect transistor (JFET) type optical sensor, a complementary metal-oxide semiconductor (CMOS) type optical sensor, or the like. In some instances, the optical detectors can include an array of optical sensing components. In some instances, the optical detector(s) can include a waveguide.

The optical detector(s) can also include one or more bandpass filters and/or focusing optics. In some instances, the optical detector(s) can include one or more photodiode detectors, each with an optical bandpass filter tuned to a specific wavelength range. Signals from the optical detector(s) can be conveyed to a processor for analysis, such as a microprocessor which can perform various operations on the signals including detecting magnitudes of signal intensity, filtering operations, averaging signals, converting signals into concentrations of analytes of interest utilizing a predetermined correlation, or the like.

### Optical Feedthrough

Referring to FIGS. 5A-5C, the optical feedthrough 400 includes a bottom portion 410, and a side wall portion 420 surrounding a periphery of the bottom portion 410 to create a well 422. Three optical windows 432, 434 and 436 are formed through the bottom portion 410 of the optical feedthrough 400 although a different number of optical windows can be formed. For example, the optical feedthrough 400 could include a single optical window or two optical windows and then a mask or coating could be used to create sub-windows or areas for light to pass through and to create other areas where light is limited or blocked from passing through the optical window.

Portions of the optical feedthrough 400 such as a ferrule can be formed of a biocompatible material such as, for example, titanium or a titanium alloy, and the material can be electrically conductive in certain instances. The optical windows can be formed of glass, crystal, ceramic, polymer, or the like, including, for example, quartz, silica, or sapphire. In various instances, the optical windows can be formed of a low-index glass, crystal, ceramic, or polymer, such as one having an index of refraction of 1.5 or less. In some instances, the optical windows can have an anti-reflective coating thereon to reduce light reflection when light transmits through the optical windows.

Referring again to FIGS. 4A and 4B, the optical feedthrough 400 can be assembled with the opto-electronic assembly 300 where the bottom portion 410 of the optical feedthrough 400 can be positioned on (or otherwise coupled to) the top of the optical seal 330. The first optical window 432 of the optical feedthrough 400 is arranged to receive light emitted by one or more of the optical emitters 322, the second optical window 436 is arranged to receive light emitted by another one or more optical emitters 326, and the third optical window 434 is arranged to pass light to the optical detector 324. While two optical emitters are shown as being aligned with each of the optical windows 432 and 436, it is to be understood that a different number of optical emitters can be used for an optical window. The optical fill material 340 can fill the space between the corresponding optical window and the respective optical emitter/detector.

As shown in FIG. 5B, the side wall portion 420 of the optical feedthrough 400 further includes a recessed rim 424, onto which edges of the top housing shell 114 surrounding the sensor window 118 can rest (FIG. 3). The optical feedthrough 400 can further include a top cover 440 (FIG. 3) which can securely and engage an undercut lip 426 of the side wall portion 420 to enclose the chemical sensor cassette 500 inside the well 422. In some instances, the top cover 440 may be integrated with the chemical sensor cassette 500 as opposed to the feedthrough 400. The top cover 440 can fit flush with an outer surface of the top housing shell 114 (FIG. 3).

As shown in FIG. 5C, the bottom portion 410 includes a bottom surface 412 which can contact the top portion of the optical seal 330 (FIG. 4A). Seals 414 can be formed around a periphery of the corresponding optical windows 432, 434 and 436. A portion of the seals 414 can engage the top portion of the optical seal 330 (FIG. 4A). In some instances, the seals 414 can be formed of a metal or a metal alloy such as, for example, gold or gold alloys. Example methods for creating the seals 414 include diffusion bonding and brazing (e.g., vacuum brazing). Diffusion bonding can involve using materials that form bonds with the optical windows 432, 434 and 436 or coatings on the optical windows 432, 434 and 436 and contain materials like nickel and or titanium. Brazing process can involve coating the optical windows 432, 434 and 436 with bonding layers such as titanium, chromium, molybdenum, tantalum, niobium, vanadium, tungsten, platinum, palladium, ruthenium, or iridium. Coating can be accomplished using methods such as vapor deposition, sputtering, plasma spraying, thermal evaporation, etc. The coating can be as thin as a few atomic layers to 200 μm. Once coated, the optical windows 432, 434 and 436 are assembled into the ferrules with braze preforms. The preforms provide material to form the seals 414 between the optical windows 432, 434 and 436 and metal ferrules.

In some instances, the optical feedthrough 400 can be formed of a metal (such as titanium or a titanium alloy) to allow for the optical feedthrough 400 to be welded into place within the sensor window 118 defined by the top housing shell 114 (FIG. 3).

### Chemical Sensor Cassette

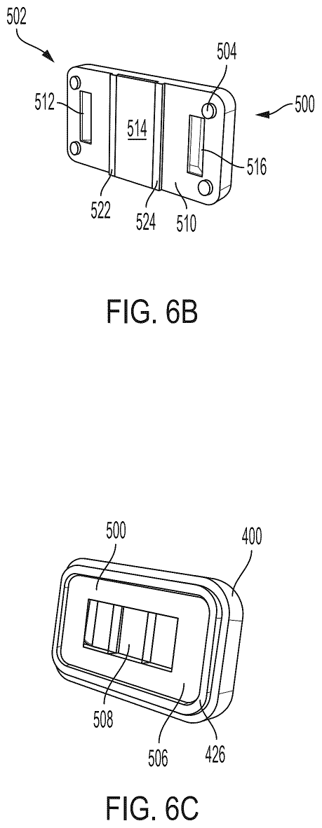

Referring to FIGS. 6A-6C, the chemical sensor cassette 500 includes a cassette housing 502 including an interior space 505. The cassette housing 502 includes a bottom portion 510. Three bottom optical apertures 512, 514, and 516 are formed through the bottom portion 510 although a different number of apertures can be formed. The bottom optical apertures 512, 514, and 516 can be respectively aligned with the optical windows 432, 434 and 436 of the optical feedthrough 400 (FIGS. 5A-C) when the chemical sensor cassette 500 is positioned in the well 422 of the optical feedthrough 400.

As shown in FIG. 6A, the chemical sensor cassette 500 includes one or more chemical indicators 534 positioned in the interior space 505 and aligned with the bottom aperture 514. First reflector 532 and second reflector 536 are also positioned in the interior space 505 to direct light to or from the chemical indicators 534. It is to be understood that a different number of reflectors can be used with the chemical sensor cassette 500. The first reflector 532 and the second reflector 536 are positioned inside the respective optical chambers 533 and 537 and aligned with the respective bottom optical apertures 512 and 516. In some instances, the first reflector 532 is arranged to receive light from the optical windows 432, 434 and/or 436 of the optical feedthrough 400 and reflect light towards the chemical indicator 534. In some instances, the second reflector 536 is arranged for one of the following: (1) to receive light from the optical aperture 516 and reflect light towards the chemical indicator 534, or (2) to receive light reflected by the first reflector 532 and transmitted through the chemical indicator 534, and reflect the light towards the optical aperture 516.

As shown in FIG. 6B, in some instances, the optical apertures 512 and 516, which can be aligned with the corresponding optical emitters 322 and 326, each have a slot shape (e.g., a rectangular shape or elongated shape). The optical aperture 514, which can be aligned with the corresponding optical detector 324, is in the form of an optical window which can be relatively wider than the slot shape. Bars 522 and 524 are positioned between the optical apertures 512, 514 and 516 to prevent undesired crosstalk between the adjacent optical apertures/channels.

As shown in FIG. 6B, in some instances, the cassette housing 502 has standoff protrusions 504 positioned at or near each corner of the bottom portion 510 of the cassette housing 502. The standoff protrusions 504 are configured to contact the corresponding corners of the bottom surface 423 of the well 422 and control the spacing between the bottom portion 510 of the cassette housing 502 and the bottom surface 422 of the well 422 of the optical feedthrough 400.

As shown in FIG. 6C, the chemical sensor cassette 500 is at least partially positioned inside the optical feedthrough 400. The undercut lip 426 of the optical feedthrough 400 can fit flush with a top surface 506 of the chemical sensor cassette 500. A top window 508 is positioned on the top surface 506. The top window 508 is designed to permit desired analytes to be in communication with the chemical indicators. For example, analytes can diffuse through an outer barrier layer of the top window 508 and to the chemical indicators of the chemical sensor cassette 500. As the concentration of a given analyte changes, optical properties of the chemical indicators can change.

In some instances, the top surface 506 of the chemical sensor cassette 500 can include a mask coating. The mask coating can be disposed on the top surface 506. The mask coating can be an opaque material and reduce the amount of ambient light from entering the inside of the chemical sensor cassette 500 and to reduce undesirable light leak paths. In some instances, the mask coating can include carbon black and/or various pigments or components to render the coating opaque.

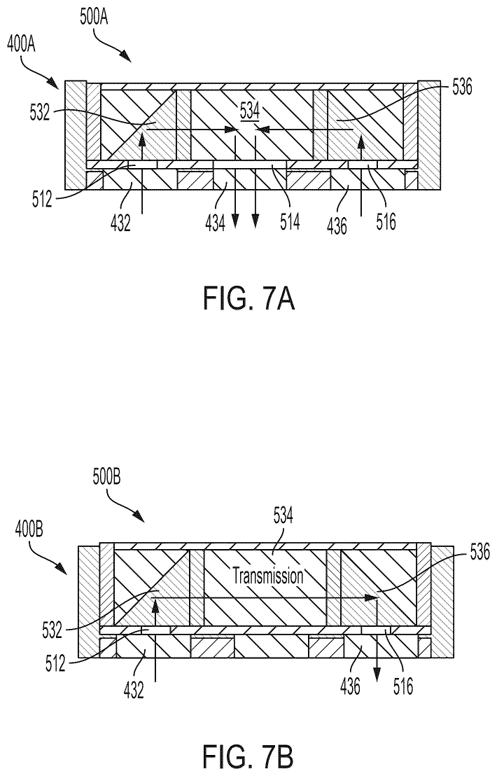

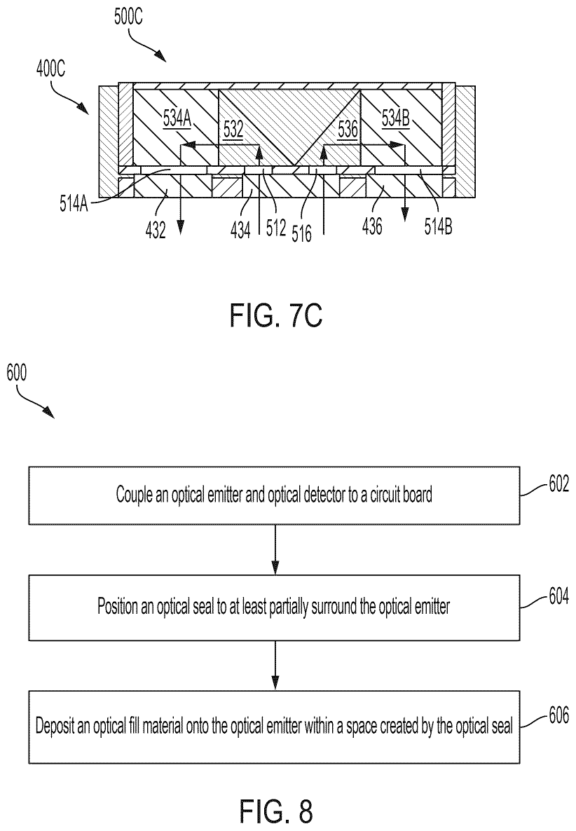

FIG. 7A-7C show different configurations of the chemical sensor cassette 500.

In some instances, as shown in FIG. 7A, a chemical sensor cassette 500A is at least partially positioned inside an optical feedthrough 400A such that first, second and third optical aperture 512, 514 and 516 of the chemical sensor cassette 500A are respectively aligned with first, second and third optical windows 432, 434 and 436 of the optical feedthrough 400A. The chemical sensor cassette 500A includes a first reflector 532 and a second reflector 536 disposed on opposite sides of chemical indicators 534. The first reflector 532 is arranged to receive light from a first optical emitter (e.g., the optical emitter 322 of FIG. 4B) through the first optical window 432 and the first optical aperture 512 and reflect the light towards the chemical indicator 534. The second reflector 536 is arranged to receive light from a second optical emitter (e.g., the optical emitter 326 of FIG. 4B) through the second optical window 436 and the second optical aperture 516 and direct the light towards the chemical indicator 534. Backscattered light from the chemical indicator 534 can be directed downwards through the optical aperture 514 and the optical window 434 towards an optical detector (e.g., the optical detector 324 of FIG. 4B).

In some instances, as shown in FIG. 7B, a chemical sensor cassette 500B is at least partially positioned inside an optical feedthrough 400B such that first and second optical aperture 512 and 516 of the chemical sensor cassette 500B are respectively aligned with first and second optical windows 432 and 436 of the optical feedthrough 400B. The chemical sensor cassette 500B includes a first reflector 532 and a second reflector 536 disposed on opposite sides of a chemical indicator 534. The first reflector 532 is arranged to receive light from a first optical emitter (e.g., the optical emitter 322 of FIG. 4B) through the first optical window 432 and the first optical aperture 512 and reflect the light towards the chemical indicator 534. The chemical indicator 534 can work in a transmission mode such that the light from the first reflector 532 transmits through the chemical indicator 534 towards the second reflector 536. The second reflector 536 is arranged to receive light reflected by the first reflector 532 and reflect light downwards through the second optical aperture 516 and the second optical window 436 towards an optical detector (e.g., the optical detector 324 of FIG. 4B).

In some instances, as shown in FIG. 7C, a chemical sensor cassette 500C is at least partially positioned inside an optical feedthrough 400C. The chemical sensor cassette 500C includes a first reflector 532 and a second reflector 536 positioned back-to-back, a first chemical indicator 534A and a second chemical indicator 534B positioned on opposites of the first and second reflectors 532 and 536. The first reflector 532 is arranged to receive light from an optical emitter (e.g., the optical emitter 322 of FIG. 4B) through the second optical window 434 and the optical aperture 512 and reflect light towards the first chemical indicator 534A. The second reflector 536 is arranged to receive light from the same optical emitter (e.g., the optical emitter 322 of FIG. 4B) through the optical window 434 and the optical aperture 516 and reflect the light towards the second chemical indicator 534B. The first chemical indicator 534A can work in a scattering mode to scatter the light from the first reflector 532 downwards through the optical aperture 514A and the first optical window 432 towards a first optical detector. The second chemical indicator 534B can work in a scattering mode to scatter the light reflected from the second reflector 536 downwards through the optical aperture 514B and the optical window 436 towards a second optical detector. The second optical detector can be different from the first optical detector.

In some instances, a reflector (e.g., the reflectors 532, 536) described herein can include a reflecting facet to reflect light. The reflecting facet may include a metallized or silvered coating thereon to promote reflection.

In some instances, the reflector can be a flat reflector including, for example, a flat reflecting facet. In some instances, the reflector can be a curved reflector including, for example, a curved reflecting facet.

In some instances, the reflector can be angled at 30 to 60 degrees relative to a bottom surface of the interior space 505.

In some instances, a reflector (e.g., the reflectors 532, 536) described herein can include a prism to redirect light. The prism can be configured to change the direction of the light by approximately 90 degrees (such as with a right-angle prism), though other angles are also contemplated herein such as between 45 and 120 degrees. The prism can be formed of various materials including glasses, crystals, ceramics, polymers, and the like. The prism can be of various sizes. In some instances, the prism can be reflector prism including flat or curved optical collection features.

In some instances, a prism holder can be configured to both hold the prism and fit over an optical emitter (such as an LED) providing a means for consistently aligning the prism with the optical emitter. In some instances, the prism holder can be formed of a plastic material, though other materials are contemplated herein. The prism holder can hold the prism utilizing a snap-fit mechanism and/or other means of fixation such as adhesive bonding and the like.

In some instances, the cassette housing 502 can be formed of an opaque or black material (e.g., PMMA) to prevent ambient light from entering the interior space 505. The opaque or black material can include components such as carbon black or various pigments or dyes to be opaque to the passage of light. In some instances, the prism can be formed of an optically transparent material (e.g., PMMA).

### Chemical Sensing Chemistry

In certain instances, color of the chemical indicator 534 comprises the sum of the absorption, transmission, reflectance, and fluorescence properties of the chemical indicator material. Put another way, the chemical indicator 534 can comprise a material that changes optical properties with changes in concentration of a given analyte—and such optical properties can be measured by analyzing an image of the chemical indicator 534.

In certain instances, the chemical indicator 534 is formed of a lipophilic indicator dye (e.g., a lipophilic fluorescent indicator dye or a lipophilic colorimetric indicator dye). Lipophilic indicator dyes can include, but are not limited to, ion selective sensors such as ionophores or fluorophores. In certain instances, ionophores can include sodium-specific ionophores, potassium-specific ionophores, calcium-specific ionophores, magnesium-specific ionophores, and lithium-specific ionophores. In certain instances, fluorophores can include lithium-specific fluorophores, sodium-specific fluorophores, and potassium-specific fluorophores.

Compositions of the chemical indicator 534 can include components (or response elements) that are configured for a colorimetric response, a photoluminescent response, or another optical sensing modality. For example, the chemical indicator 534 can include an element that changes color based on binding with or otherwise complexing with a specific chemical analyte. As one specific example, creatinine reacts with a molecule which changes pH and color on the indicator. In some instances, the chemical indicator 534 can include a complexing moiety and a colorimetric moiety. Those moieties can be a part of a single chemical compound (e.g., a non-carrier-based system) or can be separated on two or more different chemical compounds (e.g., a carrier-based system). The colorimetric moiety can exhibit differential light absorbance on binding of the complexing moiety to an analyte.

Some of the chemical indicators 534 may not require a separate compound to both complex an analyte of interest and produce an optical response. By way of example, in some instances, the response element can include a non-carrier optical moiety or material wherein selective complexation with the analyte of interest directly produces either a colorimetric or fluorescent response. As an example, a fluoroionophore can be used and is a compound including both a fluorescent moiety and an ion complexing moiety. As merely one example, (6,7-[2.2.2]-cryptando-3-[2″-(5″-carboethoxy)thiophenyl]coumarin, a potassium ion selective fluoroionophore, can be used (and in some cases covalently attached to polymeric matrix or membrane) to produce a fluorescence-based K+ non-carrier response element. An exemplary class of fluoroionophores are the coumarocryptands. Coumarocryptands can include lithium specific fluoroionophores, sodium specific fluoroionophores, and potassium specific fluoroionophores. For example, lithium specific fluoroionophores can include (6,7-[2.1.1]-cryptando-3-[2″-(5″-carboethoxy)furyl]coumarin. Sodium specific fluoroionophores can include (6,7-[2.2.1]-cryptando-3-[2″-(5″-carboethoxy)furyl]coumarin. Potassium specific fluoroionophores can include (6,7-[2.2.2]-cryptando-3-[2″-(5″-carboethoxy)furyl]coumarin and (6,7-[2.2.2]-cryptando-3-[2″-(5″-carboethoxy)thiophenyl]coumarin.

Analytes detected herein can include, but are not limited to, potassium, sodium, calcium, blood urea nitrogen (BUN), creatinine, and the like.

### Methods

FIG. 8 shows a block diagram of an example method 600 for making the chemical sensor described herein. The method 600 includes coupling one or more optical emitters and one or more optical detectors to the circuit board (block 602 in FIG. 8). This can include soldering inputs (e.g., leads) of the optical emitter(s) to conductive pads on the circuit board. The method 600 further includes positioning an optical seal to at least partially surround the optical emitter or the optical detector (block 604 in FIG. 8). In instances with multiple optical emitters, the optical seal can surround multiple optical emitters. The optical seal can also surround the optical emitter(s).

The method 600 further includes depositing an optical fill material onto the optical emitter within a space created by the optical seal (block 606 in FIG. 8). For example, the optical fill material can be deposited to fill the space between walls of the optical seal. In certain instances, the optical seal is first coupled to the circuit board and then the optical fill material is deposited into the optical seal. After depositing the optical fill material, the optical feedthrough assembly can be coupled to the opto-electronic assembly. Pressure can be applied to force the optical fill material through the one or more vent holes in the circuit board. As previously noted, this can help reduce air bubbles, air pockets, etc., in the optical fill material. Once the optical fill material is deposited, the optical fill material can be cured (e.g., via heating, via UV exposure).

### Circuitry

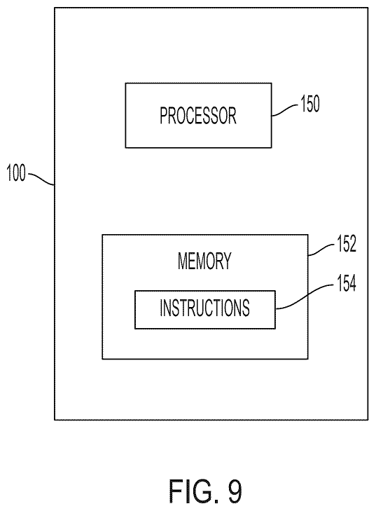

FIG. 9 shows a block diagram of certain circuitry (e.g., integrated circuit shown in FIG. 3) of the IMD 100. The circuitry includes a processor 150 such as a microprocessor. The circuitry also includes memory 152 and instructions 154. The instructions 154 may be configured to be executed by the processor 150 and, upon execution, to cause the processor 150 to perform certain processes and functions described herein. The processor 150, memory 152, and instructions 154 can be part of a controller such as a controller used by an application specific integrated circuit (ASIC), field-programmable gate array (FPGA), and/or the like. Such devices can be used to carry out the functions and steps described herein.

In certain instances, the memory 152 includes computer-readable media in the form of volatile and/or nonvolatile memory. Media examples include random access memory (RAM), read only memory (ROM), electronically erasable programmable read only memory (EEPROM), flash memory, and/or any other medium that can be used to store information and can be accessed by a computing device such as the processor 150. In instances, the memory stores the computer-executable instructions 154 for causing the processor 150 to implement aspects of instances of components discussed herein and/or to perform aspects of instances of methods and procedures discussed herein. The memory 152 can comprise a non-transitory computer readable medium storing the computer-executable instructions 154.

The computer-executable instructions 154 may include, for example, computer code, machine-useable instructions, and the like such as, for example, program components capable of being executed by one or more processors associated with the computing device 150. Program components may be programmed using any number of different programming environments, including various languages, development kits, frameworks, and/or the like. Some or all of the functionality contemplated herein may also, or alternatively, be implemented in hardware and/or firmware.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, can be implemented by computer program instructions.

Various modifications and additions can be made to the exemplary instances discussed without departing from the scope of the present invention. For example, while the instances described above refer to particular features, the scope of this invention also includes instances having different combinations of features and instances that do not include all of the described features. Accordingly, the scope of the present invention is intended to embrace all such alternatives, modifications, and variations as fall within the scope of the claims, together with all equivalents thereof.

We claim:

1. An apparatus including an opto-electronic assembly, the opto-electronic assembly comprising:
a substrate;
an optical emitter coupled to the substrate;
an optical detector coupled to the substrate; and
an optical seal at least partially surrounding the optical emitter and arranged to confine light emitted by the optical emitter.

2. The apparatus of claim 1, wherein the substrate includes a vent hole extending through a thickness direction of the substrate.

3. The apparatus of claim 1, wherein the substrate is formed of an opaque core material.

4. The apparatus of claim 1, wherein the substrate further comprises an anti-reflective solder mask layer.

5. The apparatus of claim 1, wherein the opto-electronic assembly further comprises an optical fill material at least partially arranged within the optical seal, wherein the optical fill material is directly coupled to an emitting surface of the optical emitter, wherein the optical fill material is also directly coupled to a receiving surface of the optical detector.

6. The apparatus of claim 1, wherein the optical emitter is a first optical emitter configured to emit light at a first frequency, wherein the opto-electronic assembly includes a second optical emitter coupled to the substrate and configured to emit light at a second frequency, wherein the optical seal at least partially surrounds the second optical emitter.

7. The apparatus of claim 1, wherein the opto-electronic assembly further comprises an optical fill material at least partially arranged within the optical seal, wherein the optical fill material is an adhesive.

8. The apparatus of claim 1, wherein the optical emitter is a light-emitting diode, wherein the optical detector is a photodiode.

9. The apparatus of claim 1, wherein the apparatus is an implantable medical device with a housing that houses the opto-electronic assembly, wherein the optical emitter and the optical detector are directly coupled to a first major surface of the substrate, wherein a desiccant is directly coupled to a second major surface of the substrate and to the housing.

10. The apparatus of claim 1, further comprising an optical feedthrough assembly that comprises:
a bottom portion;
a side wall portion surrounding a periphery of the bottom portion to create a well; and
a first window and a second window formed through the bottom portion of the optical feedthrough, wherein the first window is arranged to receive the light emitted by the optical emitter, wherein the second window is arranged to pass reflected light to the optical detector.

11. The apparatus of claim 10, wherein the opto-electronic assembly further comprises an optical fill material at least partially arranged within the optical seal, wherein the optical fill material at least partially fills a first region between the first window and an emitting surface of the optical emitter.

12. The apparatus of claim 11, wherein the optical fill material at least partially fills a second region between the second window and a detecting surface of the optical detector.

13. The apparatus of claim 10, further comprising a chemical sensor cassette at least partially positioned in the well.

14. The apparatus of claim 13, wherein the chemical sensor cassette comprises bottom apertures respectively aligned with the first window and the second window.

15. The apparatus of claim 14, wherein the optical chemical sensor cassette further comprises:
a cassette housing with the bottom apertures respectively facing the optical emitter and the optical detector;
a reflector coupled to the cassette housing; and
a chemical indicator in the cassette housing,
wherein the reflector is configured to direct the emitted light to the chemical indicator.

16. A method for making a chemical sensor with an opto-electronic assembly that includes an optical emitter and an optical detector, the method comprising:
coupling the optical emitter to a substrate;
coupling the optical detector to the substrate;
positioning an optical seal to at least partially surround the optical emitter; and
depositing an optical fill material onto the optical emitter within a space created by the optical seal.

17. The method of claim 16, further comprising:
coupling an optical feedthrough assembly to the opto-electronic assembly; and
applying a pressure to force the optical fill material through a vent hole in the substrate.

18. The method of claim 17, wherein optical fill material is directly coupled between an emitting surface of the optical emitter and to a window in the optical feedthrough assembly.

19. The method of claim 16, further comprising:
coupling an optical feedthrough assembly to the opto-electronic assembly; and
inserting a cassette into a well of the optical feedthrough, wherein the cassette includes a chemical indicator that changes color with changes in analyte concentrations.

20. The method of claim 16, further comprising:
curing the optical fill material.
